(19) United States
(12) Patent Application Publication
(10) Pub. No.: US 2006/0282421 A1
(43) Pub. Date: Dec. 14, 2006

(54) Unilaterally throttling the creation of a result set in a federated relational database management system

(75) Inventors: Paul Michael Cadarette, Hemet, CA (US); Gregg Andrew Upton, Santa Clara, CA (US); Anil Venkatesh Varkhedi, San Jose, CA (US)

Correspondence Address: INTERNATIONAL BUSINESS MACHINES CORP;IP LAW, 555 BAILEY AVENUE , J46/G4, SAN JOSE, CA, 95141, US

(73) Assignee: International Business Machines Corporation

(21) Appl. No.: 11/150,371

(22) Filed: Jun. 10, 2005

(51) Int. Cl. G06F 17/30

(52) U.S. Cl. 707/4

(57) ABSTRACT

Various embodiments of a method, system and article of manufacture to retrieve data in the form of rows from a federated relational database management system are provided. One or more client-requests from a client are received. In response to at least one of the client-requests, one or more fetch resource requests are issued to a native database management system interface. In response to the one or more fetch resource requests, one or more rows, respectively, are received from the native database management system interface. The one or more rows are stored in a cache. The issuing of at least one of the fetch resource requests is suspended based on a number of the rows in the cache reaching a predetermined upper threshold.

### BACKGROUND OF THE INVENTION

1.0. Field of the Invention

This invention relates to creating a result set, and more particularly to unilaterally throttling the creation of a result set in a federated relational database management system.

2.0. Description of the Related Art

Database management systems allow large volumes of data to be stored and accessed efficiently and conveniently in a computer system. In a database management system, data is logically organized in a manner specific to the type of database management system. There are various types of database management systems, for example, hierarchical database management systems, for example, IBM® (Registered trademark of International Business Machines Corporation) Information Management System (IMS™) (Trademark of International Business Machines Corporation), network database management systems, for example, Computer Associates' Integrated Data Management System (CA-IDMS® (Registered Trademark of Computer Associates International, Inc.)), and relational database management systems, for example, IBM DB2® (Registered trademark of International Business Machines Corporation). In a relational database management system, data is stored in database tables which organize the data into rows and columns; and specified columns associate the tables with each other.

The database management system responds to user commands to store and access data. In a relational database management system, the commands are typically Structured Query Language (SQL) statements such as SELECT, INSERT, UPDATE and DELETE, to select, insert, update and delete, respectively, the data in the rows and columns. The SQL statements typically conform to a SQL standard as published by the American National Standards Institute (ANSI) or the International Standards Organization (ISO).

A federated database management system can access data from multiple, heterogeneous data sources. The data sources may be relational or non-relational sources. IBM Websphere® (Registered trademark of International Business Machines Corporation) Information Integrator Classic Federation for z/OS® (Registered trademark of International Business Machines Corporation) is a federated relational database management system which provides SQL access to z/OS relational and non-relational databases. Access to IBM Websphere Information Integrator Classic Federation is provided through open database connectivity (ODBC) and Java® (Registered Trademark of Sun Microsystems Inc.) database connectivity (JDBC® (Registered Trademark of Sun Microsystems, Inc.)) drivers.

Generally, in the client/server software architecture, a client is a requester of services and a server is the provider of services. For example, the client comprises the client application and driver, and the server is the database management system, such as IBM Websphere Information Integrator Classic Federation. Client applications using ODBC or JDBC drivers communicate with the federated relational database management system using the client/server request/response paradigm. Once a session is established between the client application and the federated relational database management system, the client issues one or more SQL statements to retrieve data from the server, that is, the federated relational database management system, which returns a result set. In particular, in response to a SQL SELECT statement from the client application, the driver issues a SQL Open statement and then repeatedly issues SQL fetch messages (requests) to the federated relational database management system. The federated relational database management system responds with data for each SQL fetch message (response). The end of the data is indicated by the federated relational database management system sending a response containing an end-of-data indicator.

Typically, the client application and driver, such as ODBC or JDBC, is on a client computer system; and the database management system is on a server computer system. The client computer system typically runs slower than the server computer system. This results in long idle times of no processing on the server computer system. To improve performance, the database management system on the server computer system can pre-fetch blocks of result set rows and store the rows in a cache in anticipation of the next incoming SQL fetch request from the client. This practice reduces the transition time on subsequent SQL fetch requests and improves performance. The query processor of the Information Integrator Classic Federation relational database management system is threaded to support such idle-time processing of result sets. Therefore in between incoming SQL fetch requests from the client, the Information Integrator Classic Federation Query Processor continues to store blocks of result set rows in the cache until the result set is complete, or it is interrupted by another SQL fetch request.

FIG. 1 depicts a sequence diagram illustrating the flow of fetch requests and data using conventional processing. In this example, rows are returned to the client in blocks, and a block contains two rows. A client computer system 6 has a client application 8 and a driver 10. The client application 8 issues a SQL SELECT statement 12 against a federated relational database management system 18, such as Websphere Information Integrator Classic Federation. For example, a SQL SELECT statement may be “SELECT*FROM big table”. In response to the SQL SELECT statement 12, the driver 10 issues a SQL Open statement 14 to a query processor 16 of a federated relational database management system 18. In the federated relational database management system 18, a query processor 16 receives and processes SQL statements. In response to the SQL Open 14, the query processor 16 issues a series of fetch resource requests 20, to a native database management system (DBMS) interface 22 using a background thread. In some embodiments, the native DBMS interface 22 and the native database management system 23 are on the same computer system as the federated relational database management system 18. In other embodiments, the native DBMS interface 22 and the native database management system 23 are on a different computer system from the federated relational database management system 18. In the native DBMS interface 22, a native DBMS connector 21 receives the fetch resource requests 20 and retrieves the data using native calls and native responses 23 of the native database management system 23. The native database management system 23 may be a hierarchical, a network, or a relational database management system. In response to the fetch resource requests 20, the query processor 16 receives rows 24 from the native database management system 23, via the native DBMS interface 22, to create a result set. Meanwhile, the query processor 16 also returns an indication 26 that the SQL Open 14 succeeded, an OK 26, to the driver 10. The query processor 16 continues to issue fetch resource requests 20 to the native DBMS interface 22 and stores the returned rows 24 in a cache 28 until the end of the data is reached. Meanwhile, the driver 10 issues a series of SQL fetch requests 30. In response to each SQL fetch request 30, the query processor 16 accesses the cache 28 and returns a block 32 to the driver 10. The block 32 contains a predetermined number of rows. The driver 10 continues to issue SQL fetch requests 30 until all the blocks 32 of the result set are returned.

The creation of a result set using a background thread can result in an increased CPU utilization percentage from the columnar processing being executed over a small period of time and an increased shared memory footprint because the server computer system is typically faster than the client computer system. Therefore, the background thread may dominate the processing on the server computer system until the background thread is either interrupted by a request from the client computer system or the result set is complete. While the performance improvements attained using pre-fetch and caching are significant, there is a tendency for the server computer system to overuse server resources for particularly slow client computer systems. Allowing the background thread to dominate the server computer system's processing may cause other threads to be processed slowly. In addition, a large result set may cause the memory, for example, the cache, to overflow and processing may stop. Therefore there is a need for an improved technique to create result sets.

### SUMMARY OF THE INVENTION

To overcome the limitations in the prior art described above, and to overcome other limitations that will become apparent upon reading and understanding the present specification, various embodiments of a method, system and article of manufacture are provided to retrieve data in the form of rows from a federated relational database management system. One or more client-requests from a client are received. In response to at least one of the client-requests, one or more fetch resource requests are issued to a native database management system interface. In response to the one or more fetch resource requests, one or more rows, respectively, are received from the native database management system interface. The one or more rows are stored in a cache. The issuing of at least one of the fetch resource requests is suspended based on a number of the rows in the cache reaching a predetermined upper threshold.

In this way, an improved technique is provided for creating a result set.

### BRIEF DESCRIPTION OF THE DRAWINGS

The teachings of the present invention can be readily understood by considering the following description in conjunction with the accompanying drawings, in which:

FIG. 1 depicts a sequence diagram illustrating the flow of fetch requests and data using conventional processing;

FIG. 2 depicts a sequence diagram illustrating the throttling of a cached pre-fetched result set;

FIG. 3 depicts a flowchart of an embodiment of the processing performed in response to a SQL open from the driver of FIG. 2;

FIG. 4 comprises FIGS. 4A, 4B and 4C which collectively depict a flowchart of an embodiment of a technique which throttles a cached pre-fetched result set; and

FIG. 5 depicts an illustrative computer system which uses various embodiments of the present invention.

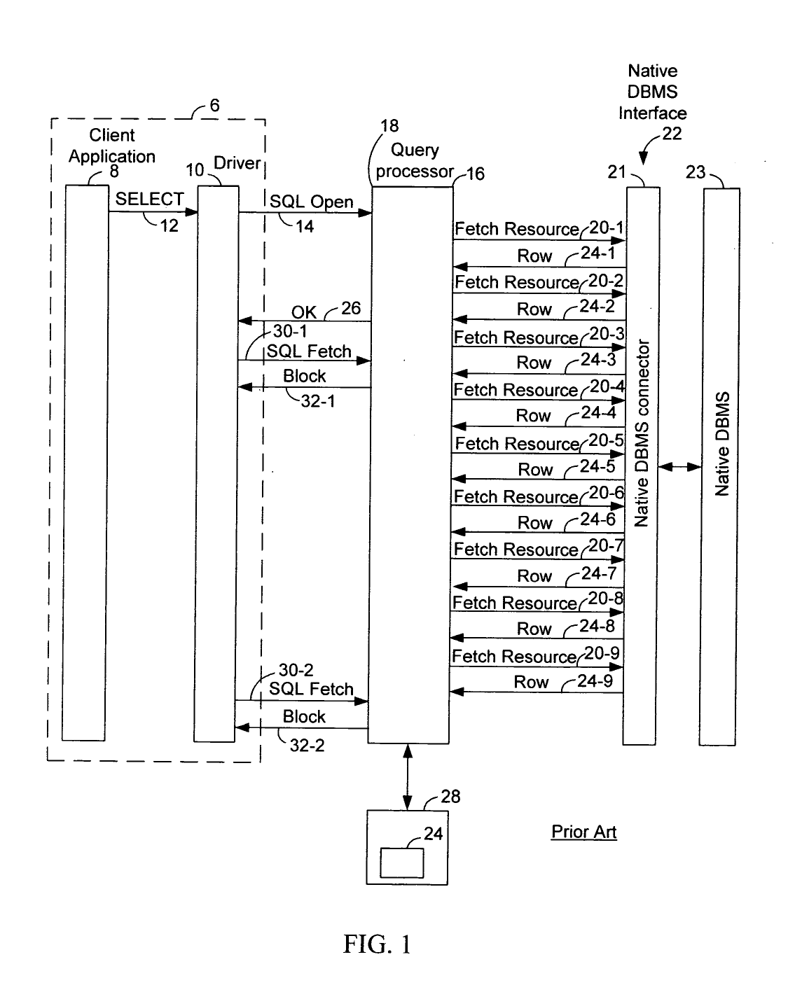

To facilitate understanding, identical reference numerals have been used, where possible, to designate identical elements that are common to some of the figures.

### DETAILED DESCRIPTION

After considering the following description, those skilled in the art will clearly realize that the teachings of the various embodiments of the present invention can be utilized to create a result set at a server. In various embodiments, a method, system and article of manufacture are provided to retrieve data in the form of rows from a federated relational database management system. One or more client-requests from a client are received. In response to at least one of the client-requests, one or more fetch resource requests are issued to a native database management system interface. In response to the one or more fetch resource requests, one or more rows, respectively, are received from the native database management system interface. The one or more rows are stored in a cache. The issuing of at least one of the fetch resource requests is suspended based on a number of the rows in the cache reaching a predetermined upper threshold.

In various embodiments, a server-based throttle technique tracks the number of fetch resource requests with respect to the creation of the result set, and suspends result set processing when the result set processing gets too far ahead of the SQL fetch requests. A cache is a buffer area formed from the computer system's memory. In some embodiments, the throttle uses an upper threshold to control a number of fetched rows in the cache to prevent the memory from overflowing, and a lower threshold to help provide a minimum number of fetched rows in the cache so that rows are available when the client requests additional rows. The overall central processing unit (CPU) time used to create the result set is the same as in using the conventional technique. However, distributing the processing over time reduces the CPU utilization percentage, and memory usage by the result set utilities.

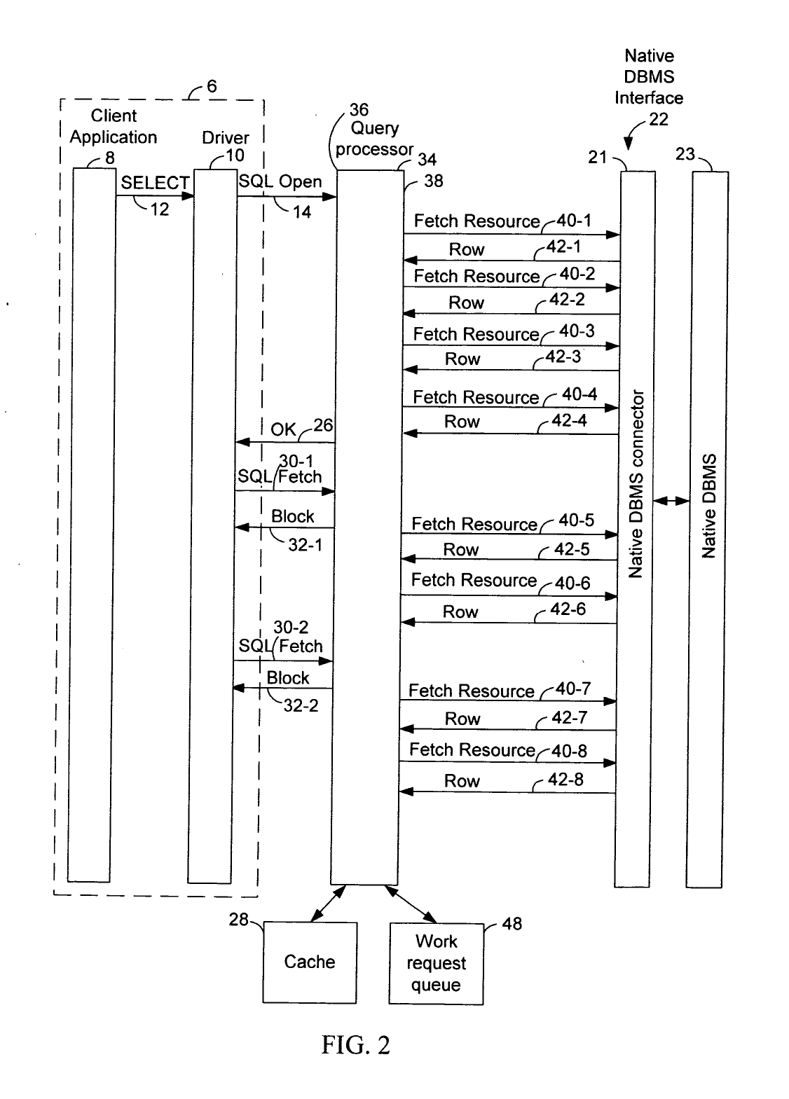

FIG. 2 depicts a sequence diagram illustrating the throttling of cached pre-fetched result sets. A client computer system 6 has a client application 8 and a driver 10. In various embodiments, the driver 10 is a JDBC or ODBC driver. The client application 8 issues a SQL SELECT statement 12. In response to the SQL SELECT statement 12, the driver 10 issues a SQL Open statement 14. The query processor 34 of a federated relational database management system 36 on a server computer system 38 receives the SQL Open statement 14 and, in response, the query processor 36 issues a series of fetch resource requests 40 to the native database management system 23 using the native DBMS interface 22. In the native DBMS interface 22, the native DBMS connector 21 receives the fetch resource requests 40 and retrieves the data using native calls and native responses of the native database management system 23. In some embodiments, the native DBMS interface 22 and the native database management system 23 are on the same computer system as the federated relational database management system 36. In other embodiments, the native DBMS interface 22 and the native database management system 23 are on a different computer system from the federated relational database management system 36. A block comprises a predetermined number of rows. In this example, a block contains two rows, and an upper threshold for the number of blocks on the result set which are stored in the cache 28 is equal to two. Therefore, in this example, the query processor 36 issues four fetch resource requests 40-1, 40-2, 40-3 and 40-4, receives rows 42-1, 42-2, 42-3 and 42-4, and stores the rows 42-1, 42-2, 42-3 and 42-4 in the cache 28. The query processor 34 then returns a success indicator, an OK 26, to the driver 10. The invention is not meant to be limited to a block containing two rows; and in other embodiments, a block comprises one or more rows.

In response to receiving the success indicator 26, the driver 10 issues a series of SQL fetch requests 30. In response to the SQL fetch request 30-1, the query processor 34 returns a block 32-1 from the cache 28. In addition, because the number of blocks in the cache 28 has been reduced by one block and is less than the upper threshold, the query processor 34 issues one or more fetch resource requests 40-5 and 40-6 to retrieve a block of rows 42-5 and 42-6 from the native DBMS interface 22. In this example, two fetch resource requests 40-5 and 40-6 are issued. In response to the fetch resource requests 40-5 and 40-6, two rows 42-5 and 42-6 are returned and stored in the cache 28. In some embodiments, the fetch resource requests 40-5 and 40-6 are placed in a work request queue 48 before being issued to the native DBMS interface 22. In this example, the query processor 34 suspends the issuing of fetch resource requests 40 to the native DBMS interface 22 after the cache 28 contains a number of blocks equal to the upper threshold, in this example, two blocks. As additional blocks 32 are returned in response to SQL fetch requests 30, additional rows will be retrieved from the native DBMS interface 22. In this way, the issuing of the fetch resource requests 40 is throttled and a block is typically available in the cache 28 to return in response to the next SQL fetch request 30.

The fetch transition time refers to an amount of time between receiving a SQL fetch request and returning a block comprising one or more rows in response to that request. In various embodiments, a technique pre-fetches and caches a sufficient number of rows to reduce, and in some embodiments to eliminate, the fetch transition time. In this way, the performance improvements of pre-fetching and using a cache are maintained, while eliminating the resource requirements of caching an entire result set on the server. An additional benefit is to distribute server processing over time, thereby reducing the CPU utilization percentage for each individual user.

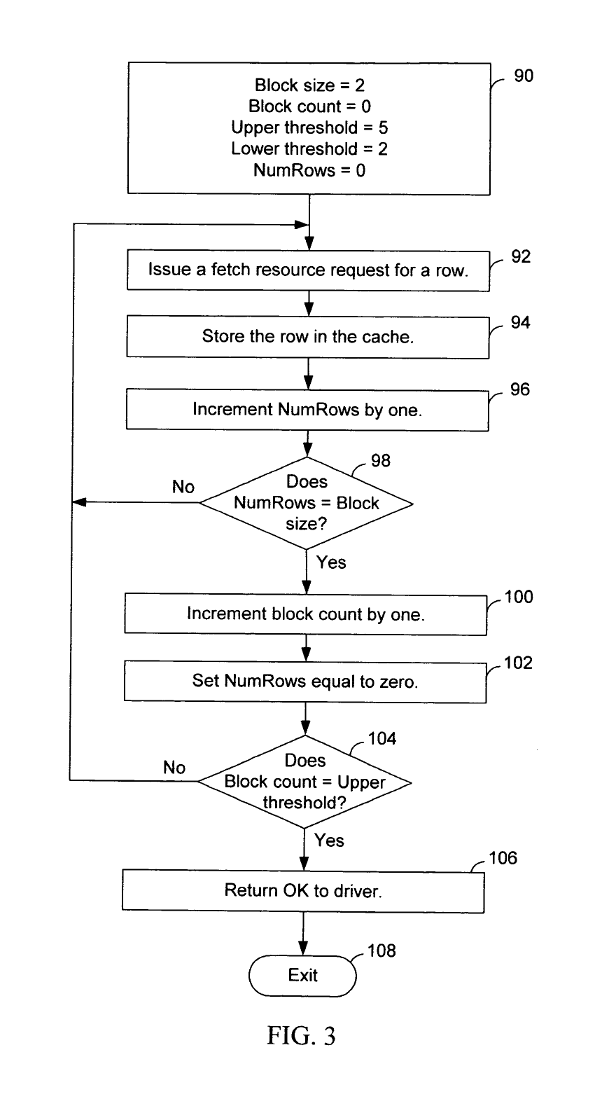

FIG. 3 depicts a flowchart of an embodiment of the processing performed by the query processor 34 (FIG. 2) in response to a SQL Open from the driver of FIG. 2. In step 90, the query processor initializes the block size, block count, upper threshold, lower threshold and number of rows (NumRows) to predetermined values. The block size is a predetermined value which represents the number of rows in the blocks. In some embodiments, the block size is set equal to two. The block count represents the number of blocks in the cache and is set equal to zero. The upper threshold represents a maximum number of blocks which are to be stored in the cache. The lower threshold represents a minimum number of blocks which are to be stored in the cache. The upper threshold is set equal to five; and the lower threshold is set equal to two. The number of rows (NumRows) is a row counter and is initialized to zero. However, the invention is not meant to be limited to a block size of two, an upper threshold of five and a lower threshold of two and other values may be used.

In step 92, the query processor issues a fetch resource request for a row. In step 94, the query processor stores the row in the cache. In step 96, NumRows is incremented by one. Step 98 determines whether NumRows is equal to the block size. If not, step 98 proceeds to step 92 to retrieve another row. In response to step 98 determining that NumRows is equal to the block size, in step 100, the block count is incremented by one. In step 102, NumRows is set equal to zero. Step 104 determines whether the block count is equal to the upper threshold. If not, step 104 proceeds to step 92. In response to step 104 determining that the block count is equal to the upper threshold, in step 106, the query processor returns an “OK” indication to the driver. The “OK” indication indicates that the SQL Open was performed successfully. In step 108, the flowchart exits.

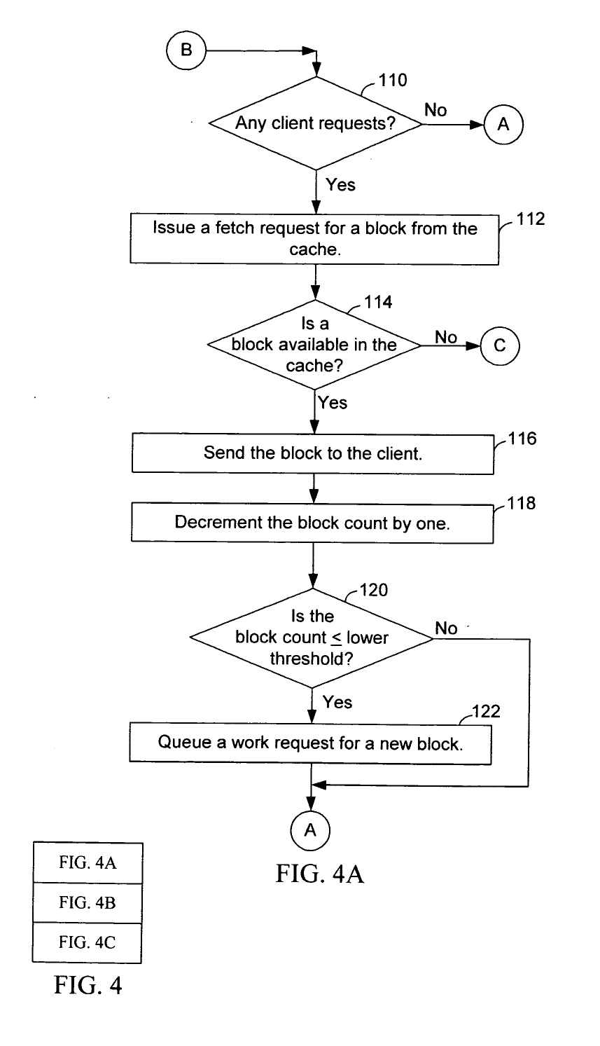

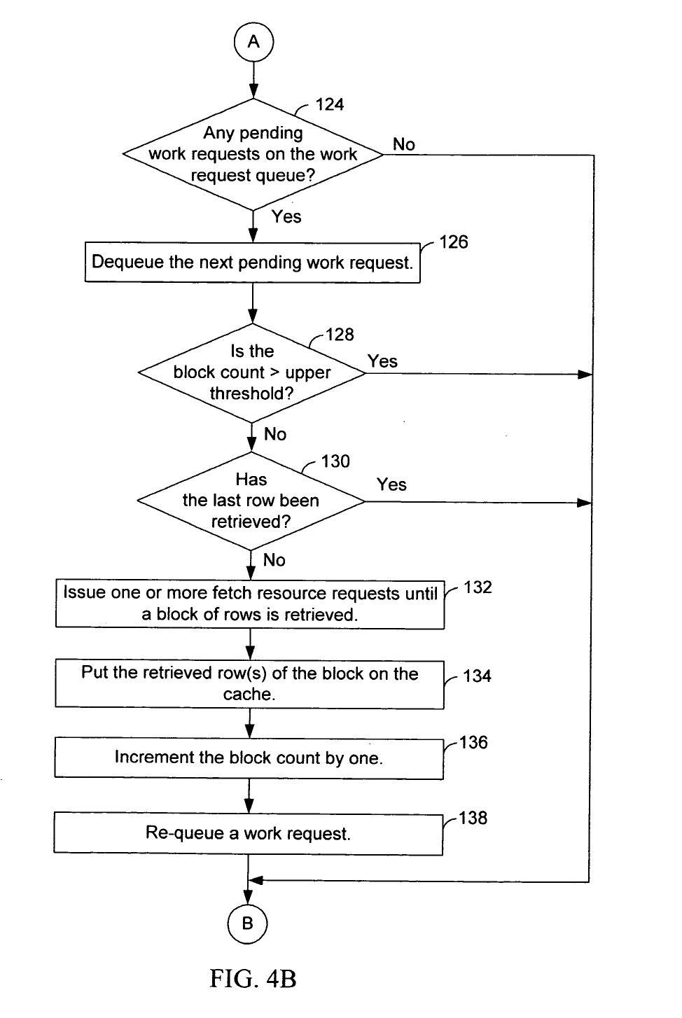

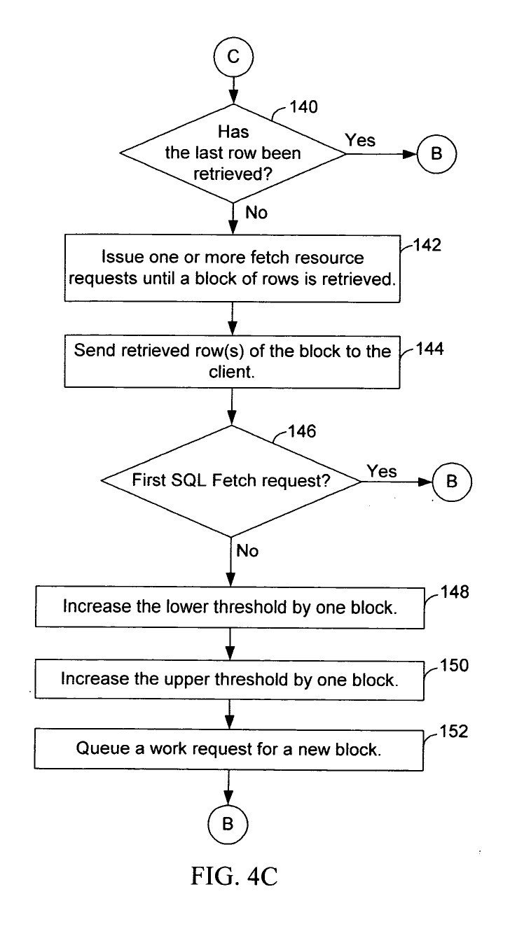

FIG. 4 comprises FIGS. 4A, 4B and 4C which collectively depict a flowchart of an embodiment of throttling cached pre-fetch result sets. In various embodiments, the flowchart of FIG. 4 is implemented in the query processor 34 (FIG. 2) of the federated relational database management system 36 (FIG. 2). In some embodiments, the flowchart of FIG. 4 is performed in response to a SQL fetch. More generally, in various embodiments, the flowchart of FIG. 4 is performed in response to a command to create and retrieve a result set.

In FIG. 4A, in step 110, the query processor determines whether there are any client requests, for example, a SQL fetch. If so, in step 112, a fetch request for a block from the cache is issued. In other words, the query processor issues a fetch request to return a block of rows from the cache. A block comprises one or more rows in accordance with the block size.

Step 114 determines whether a block is available from the cache. If so, in step 116, a block is sent from the cache to the client. In step 118, the block count is decremented by one.

Step 120 determines whether the block count is less than or equal to the lower threshold. If so, in step 122, a work request for the new block is queued, in some embodiments, to the work request queue. Step 122 proceeds via Continuator A to step 124 of FIG. 4B. If step 120 determines that the block count is not less than or equal to the lower threshold, step 120 proceeds via Continuator A to step 124 of FIG. 4B.

Step 124 of FIG. 4B determines whether there are any pending work requests on the work request queue. If so, in step 126, the next pending work request is dequeued. In other words, the next pending work request is removed from the work request queue.

Step 128 determines whether the block count is greater than the upper threshold. If not, step 130 determines whether the last row has been retrieved. In response to step 130 determining that the last row has not been retrieved, in step 132, one or more fetch resource requests are issued until a block of rows is retrieved. In some embodiments, a block of rows may have fewer than the number of rows equal to block size in response to receiving the last row of the result set. In step 134, the retrieved row(s) of the block are put on the cache in response to the fetch request for the resource. In step 136, the block count is incremented by one. In step 138, the work request is re-queued. Step 138 proceeds via Continuator B to step 110 of FIG. 4A.

If step 130 determines that no pending work requests are on the work queue, step 124 proceeds via Continuator B to step 110 of FIG. 4A. If step 124 determines that no pending work requests are on the work queue, step 124 proceeds via Continuator B to step 110 of FIG. 4A. If step 128 determines that the block count is greater than the upper threshold, step 128 proceeds via Continuator B to step 110 of FIG. 4A.

Referring back to FIG. 4A, if step 110 determines that there are no client requests, step 110 proceeds via Continuator A to step 124 of FIG. 4B. If step 114 determines that a block is not available in the cache, step 114 proceeds via Continuator C to step 140 of FIG. 4C.

In FIG. 4C, step 140 determines whether the last row has been retrieved. If so, 'step 140 proceeds via Continuator B to step 110 of FIG. 4A. In response to step 140 determining that the last row has not been retrieved, in step 142, one or more fetch resource requests are issued until a block of rows is retrieved. In step 144, the retrieved row(s) of the block is(are) sent to the client. Step 146 determines whether the SQL fetch request was the first SQL fetch request. If not, the threshold window is adjusted. In step 148, the lower threshold is increased by one block. In step 150, the upper threshold is increased by one block. In step 152, a work request is queued for a new block. Step 152 proceeds via Continuator B to step 110 of FIG. 4A.

In response to step 146 determining that the fetch request is the first SQL fetch request, step 146 proceeds via Continuator B to step 110 of FIG. 4A. In response to step 140 determining that the fetch request is the first SQL fetch request, step 146 proceeds via Continuator B to step 110 of FIG. 4A.

In an alternate embodiment, step 128 determines whether the block count is equal to the upper threshold, and if not, proceeds to step 130, and if so, proceeds to via Continuator B to step 110 of FIG. 4A. In another alternate embodiment, step 128 determines whether the block count is greater than or equal to the upper threshold, and if not, proceeds to step 130, and if so, proceeds to via Continuator B to step 110 of FIG. 4A. In some embodiments, the block count is considered to reach the upper threshold in response to the block count exceeding the upper threshold. In other embodiments, the block count is considered to reach the upper threshold in response to the block count being equal to the upper threshold.

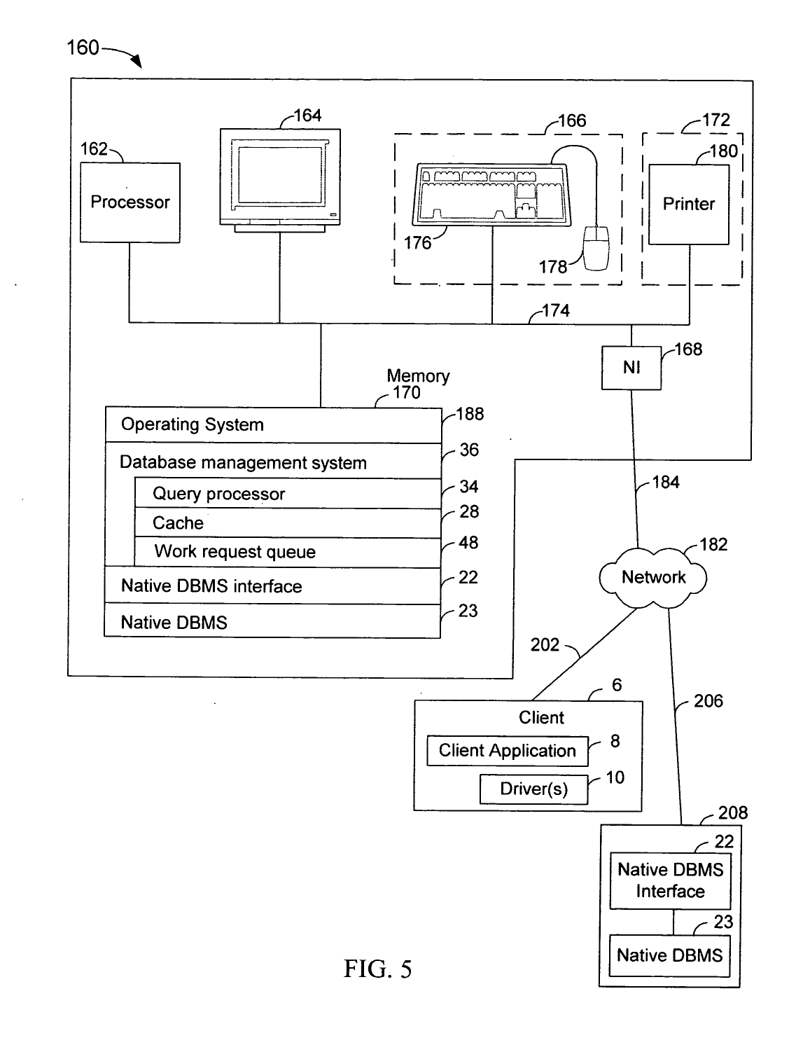

FIG. 5 depicts an illustrative computer system 160 which uses various embodiments of the present invention. In some embodiments, the computer system 160 is the computer system 38 (FIG. 2). The computer system 160 comprises a processor 162, display 164, input interfaces (I/F) 166, communications interface 168, memory 170 and output interface(s) 172, all conventionally coupled by one or more buses 174. The input interfaces 166 comprise a keyboard 176 and a mouse 178. The output interface 172 comprises a printer 180. The communications interface 168 is a network interface (NI) that allows the computer 160 to communicate via a network 182, such as the Internet. The communications interface 168 may be coupled to a transmission medium 184 such as a network transmission line, for example twisted pair, coaxial cable or fiber optic cable. In another embodiment, the communications interface 168 provides a wireless interface, that is, the communications interface 168 uses a wireless transmission medium.

The memory 170 generally comprises different modalities, illustratively semiconductor memory, such as random access memory (RAM), and disk drives. Other computer memory devices presently known or that become known in the future, or combination thereof, may be used for memory 170.

In various embodiments, the memory 170 stores an operating system 188, the database management system 36, and in some embodiments, the native DBMS interface 22 and native DBMS 23. In various embodiments, the database management system 36 comprises the query processor 34, cache 28 and work request queue 48.

In some embodiments, the network 182 is connected, via another transmission medium 202, to one or more client computer systems 6. In various embodiments, the network 182 is also connected via transmission medium 206 to another server 208 containing the native DBMS interface 22 and the native database management system 23.

In various embodiments, the specific software instructions, data structures and data that implement various embodiments of the present invention are typically incorporated in the database management system 36. Generally, an embodiment of the present invention is tangibly embodied in a computer-readable medium, for example, the memory 170 and is comprised of instructions which, when executed by the processor 162, causes the computer system 160 to utilize the present invention. The memory 170 may store the software instructions, data structures and data for any of the operating system 188, the database management system 36, in semiconductor memory, in disk memory, or a combination thereof.

The operating system 188 may be implemented by any conventional operating system such as z/OS, MVS® (Registered Trademark of International Business Machines Corporation), OS/390® (Registered Trademark of International Business Machines Corporation), AIX® (Registered Trademark of International Business Machines Corporation), UNIX® (UNIX is a registered trademark of the Open Group in the United States and other countries), WINDOWS® (Registered Trademark of Microsoft Corporation), LINUX® (Registered trademark of Linus Torvalds), Solaris® (Registered trademark of Sun Microsystems Inc.) and HP-UX® (Registered trademark of Hewlett-Packard Development Company, L.P.).

In various embodiments, the database management system 36 is IBM Websphere Information Integrator. However, the invention is not meant to be limited to IBM Websphere Information Integrator and may be used with other database management systems.

In some embodiments, the native database management system 23 is a hierarchical, networked or relational database management system. In other embodiments, a set of file access methods may be construed as a type of database management system, such as those to access flat files and spreadsheets. Examples of native database management systems comprise the IBM IMS, DB2 for z/OS, Virtual Storage Access Method (VSAM), CA-IDMS, CA-DataCom® (Registered Trademark of Computer Associates International, Inc.) or Adabas® (Registered trademark of Software AG Limited Liability Company) database management system. However, the invention is not meant to be limited to IBM IMS, DB2 for z/OS, Virtual Storage Access Method (VSAM), CA-IDMS, CA-DataCom or Adabas database management systems, and in other embodiments, the invention may be used with other native database management systems.

In various embodiments, the present invention may be implemented as a method, system, apparatus, or article of manufacture using standard programming and/or engineering techniques to produce software, firmware, hardware, or any combination thereof. The term “article of manufacture” (or alternatively, “computer program product”) as used herein is intended to encompass a computer program accessible from any computer-readable device, carrier or media. In addition, the software in which various embodiments are implemented may be accessible through the transmission medium, for example, from a server over the network. The article of manufacture in which the code is implemented also encompasses transmission media, such as the network transmission line and wireless transmission media. Thus the article of manufacture also comprises the medium in which the code is embedded. Those skilled in the art will recognize that many modifications may be made to this configuration without departing from the scope of the present invention.

The exemplary computer system illustrated in FIG. 5 is not intended to limit the present invention. Other alternative hardware environments may be used without departing from the scope of the present invention.

The foregoing detailed description of various embodiments of the invention has been presented for the purposes of illustration and description. It is not intended to be exhaustive or to limit the invention to the precise form disclosed. Many modifications and variations are possible in light of the above teachings. It is intended that the scope of the invention be limited not by this detailed description, but rather by the claims appended thereto.

What is claimed is:

1. A computer-implemented method of retrieving data in the form of rows from a federated relational database management system, comprising:
receiving one or more client-requests from a client;
in response to at least one of said client-requests, issuing one or more fetch resource requests to a native database management system interface;
in response to said one or more fetch resource requests, receiving one or more rows from said native database management system interface, respectively;
storing said one or more rows in a cache; and
suspending said issuing of at least one of said fetch resource requests in response to a number of rows in said cache reaching a predetermined upper threshold.

2. The method of claim 1 further comprising:
in response to said one or more client-requests, sending at least one of said one or more rows from said cache to said client; and
resuming said issuing of said one or more fetch resource requests.

3. The method of claim 1 wherein a block comprises a predetermined number of said rows and said upper threshold represents a predetermined number of said blocks, and said suspending of said issuing of said at least one of said fetch resource requests is performed in response to a number of said blocks in said cache reaching said predetermined upper threshold.

4. The method of claim 3 further comprising:
returning said blocks from said cache in response to said client-requests, respectively.

5. The method of claim 4 further comprising:
in response to said number of blocks in said cache being less than said upper threshold, resuming said issuing of said one or more fetch resource requests.

6. The method of claim 4 further comprising:
in response to said number of blocks in said cache being less than a lower threshold, resuming said issuing of said one or more fetch resource requests.

7. The method of claim 4 further comprising:
increasing said upper threshold in response to said cache containing no rows.

8. The method of claim 6 further comprising:
increasing said lower threshold in response to said cache containing no rows.

9. An article of manufacture comprising a computer usable medium embodying one or more instructions for performing a method of retrieving data in the form of rows from a federated relational database management system, said method comprising:
receiving one or more client-requests from a client;
in response to at least one of said client-requests, issuing one or more fetch resource requests to a native database management system interface;
in response to said one or more fetch resource requests, receiving one or more rows from said native database management system interface, respectively;
storing said one or more rows in a cache; and
suspending said issuing of at least one of said fetch resource requests in response to a number of rows in said cache reaching a predetermined upper threshold.

10. The article of manufacture of claim 9 wherein said method further comprises:
in response to said one or more client-requests, sending at least one of said one or more rows from said cache to said client; and
resuming said issuing of said one or more fetch resource requests.

11. The article of manufacture of claim 9 wherein a block comprises a predetermined number of said rows and said upper threshold represents a predetermined number of said blocks, and said suspending of said issuing of said at least one of said fetch resource requests is performed in response to a number of said blocks in said cache reaching said predetermined upper threshold.

12. The article of manufacture of claim 11 wherein said method further comprises:
returning said blocks from said cache in response to said client-requests, respectively.

13. The article of manufacture of claim 12 wherein said method further comprises:
in response to said number of blocks in said cache being less than said upper threshold, resuming said issuing of said one or more fetch resource requests.

14. The article of manufacture of claim 12 wherein said method further comprises:
in response to said number of blocks in said cache being less than a lower threshold, resuming said issuing of said one or more fetch resource requests.

15. The article of manufacture of claim 12 wherein said method further comprises:
increasing said upper threshold in response to said cache containing no rows.

16. The article of manufacture of claim 14 wherein said method further comprises:
increasing said lower threshold in response to said cache containing no rows.

17. A computer system for retrieving data in the form of rows from a federated relational database management system, comprising:
a processor; and
a memory storing one or more instructions, executable by said processor, that
receive one or more client-requests from a client;
in response to at least one of said client-requests, issue one or more fetch resource requests to a native database management system interface;
in response to said one or more fetch resource requests, receive one or more rows from said native database management system interface, respectively;
store said one or more rows in a cache; and
suspend execution of said one or more instructions that issue of at least one of said fetch resource requests in response to a number of rows in said cache reaching a predetermined upper threshold.

18. The computer system of claim 17 wherein said one or more instructions also:
in response to said one or more client-requests, send at least one of said one or more rows from said cache to said client; and
resume execution of said one or more instructions that issue said one or more fetch resource requests.

19. The computer system of claim 17 wherein a block comprises a predetermined number of said rows and said upper threshold represents a predetermined number of said blocks, and execution of said one or more instructions that issue said at least one of said fetch resource requests is suspended in response to a number of said blocks in said cache reaching said predetermined upper threshold.

20. The computer system of claim 19 wherein said one or more instructions also:
return said blocks from said cache in response to said at least one of said client-requests, respectively; and
increase said upper threshold in response to said cache containing no rows.
